(19) United States
(12) Patent Application Publication
(10) Pub. No.: US 2015/0009014 A1
(43) Pub. Date: Jan. 8, 2015

(54) APPARATUS AND METHOD FOR TRANSMITTING TAG AND READER RECEIVING APPARATUS

(71) Applicants: Electronics and Telecommunications Research Institute, Daejeon (KR); Seoul National University of Science & Technology, Foundation for Research & Business, Seoul (KR)

(72) Inventors: Sang Hyun MO, Daejeon (KR); Ji-Hoon BAE, Daejeon (KR); Hyung Chul PARK, Seoul (KR); Jae-young JUNG, Daejeon (KR); Hoe-Sung YANG, Daejeon (KR); Chan-Won PARK, Daejeon (KR); Cheol Sig PYO, Daejeon (KR)

(73) Assignees: Electronics and Telecommunications Research Institute, Daejeon (KR); Seoul National University of Science & Technology, Foundation for Research & Business, Seoul (KR)

(21) Appl. No.: 14/253,379

(22) Filed: Apr. 15, 2014

(30) Foreign Application Priority Data
Jul. 2, 2013 (KR) 10-2013-0077379

(51) Int. Cl. G06K 7/10

(52) U.S. Cl. CPC G06K 7/10366
USPC 340/10.1

(57) ABSTRACT

A tag transmitting apparatus of a passive RFID (radio frequency identification) system generates a pilot tone, a preamble, and an SFD (start frame delimiter) and transmits the pilot, the preamble, and the SFD, using one of a plurality of square waves.

### CROSS-REFERENCE TO RELATED APPLICATION

This application claims priority to and the benefit of Korean Patent Application No. 10-2013-0077379 filed in the Korean Intellectual Property Office on Jul. 2, 2013, the entire contents of which are incorporated herein by reference.

### BACKGROUND OF THE INVENTION

(a) Field of the Invention

The present invention relates to a tag transmitting apparatus and method and a reader receiving apparatus. More particularly, the present invention relates to a tag and a reader of a passive RFID (radio frequency identification) system.

(b) Description of the Related Art

RFID (radio frequency identification), a non-contact automatic recognition technology, is a technology of recognizing electronic tags on products using a radio frequency.

The RFID technology is classified, in a broad sense, into a passive RFID system and an active RFID system. In the passive RFID system, a tag is not supplied with power from a battery, but communicates with a reader on the basis of backscatter by generating self-power in response to a carrier signal from the reader.

The passive RFID system can be used for various applications in comparison to barcodes, because it can provide the information on individual objects. However, the existing passive RFID systems have problems in performance and transmission speed. The problem in performance is accuracy of a preamble code. The preamble shows a start point of the actual information signal in a transmission signal. Accordingly, the preamble is constructed of a code sequence using several bits and is detected on the basis of the auto-correlation characteristic of the code. The preamble needs to perform an additional function in the passive RFID system. That is to estimate the transmission speed of a tag transmission signal. The tag of the passive RFID system does not use an accurate clock generation signal. Further, a tolerance is provided in a transmission speed change by a standard. Transmission speed estimation is important in the existing passive RFID systems, but it is more important in a high-speed transmission RFID system. However, there is a problem in that the preamble code used in the existing RFID systems is not suitable for transmission speed estimation.

### SUMMARY OF THE INVENTION

The present invention has been made in an effort to provide a tag transmitting apparatus and method and a reader receiving apparatus having advantages of allowing estimation of a start point and transmission speed of a tag transmission signal.

An exemplary embodiment of the present invention provides a method of transmitting tag data in a passive RFID (radio frequency identification) system. The method includes generating a pilot tone, a preamble, and an SFD (start frame delimiter), generating a plurality of square waves, and transmitting the pilot tone, the preamble, and the SFD using one of the square waves.

The method further includes converting tag data inputted in series into a plurality of parallel data and transmitting the parallel data using the square waves.

The square waves may be orthogonal to each other.

The preamble may include a 4 bit signal.

The 4 bit signal may be −1, 1, 1, and −1.

The SFD may include a 4 bit signal.

The 4 bit signal may be −1, 1, 1, and −1.

The pilot tone may include a bit signal composed of zeros, and may be used for estimating transmission speed of a transmitted signal from the tag.

Another exemplary embodiment of the present invention provides a tag transmitting apparatus that transmits tag data in a passive RFID (radio frequency identification) system. The tag transmitting apparatus includes: signal generators that each generate a pilot tone, a preamble, an SFD (start frame delimiter), and tag data; a plurality of square wave generators that generate a plurality of square waves to use as subcarriers; a plurality of calculators that calculate and output input data and a plurality of square waves, respectively; a plurality of load modulators that performs load modulation on the signals of the square waves and then transmit the signals, respectively; and a demultiplexer that outputs the pilot tone, the preamble, and the SFD to one of the square wave generators, converts the tag data into a plurality of parallel data, and then outputs the parallel data to the square wave generators.

The square waves may be orthogonal to each other.

The preamble and the SFD may include a 4 bit signal.

The 4 bit signal may be −1, 1, 1, and −1.

The pilot tone may include a bit signal composed of zeros, and may be used for estimating transmission speed of the tag.

Yet another embodiment of the present invention provides reader receiving apparatus that receives a tag signal from a tag of a passive RFID (radio frequency identification) system. The reader receiving apparatus includes: a frequency estimator that estimates transmission speed offset of a received signal, using cross-correlation between a received pilot tone signal and a reference pilot tone signal, and compensates for the transmission speed offset; a preamble detector that detects whether there is a tag signal, using auto-correlation of a received preamble signal; and an SFD (start frame delimiter) detector that detects a start point of time of a payload from the tag signal, using cross-correlation between a received SFD signal and a reference SFD signal.

The pilot tone signal may be a signal obtained by performing an XOR (exclusive OR) operation on continuous 0 bit signals and a square wave.

The frequency estimator may multiply an I-signal of the pilot tone signal by one cycle signal of the square wave, multiply a Q-signal of the pilot tone signal by a cycle signal delayed by ¼ of the square wave, estimate frequency offset from the sum of the signals, and estimate transmission speed offset from the frequency offset.

The preamble signal may be obtained by performing an XOR operation on a 4 bit signal of −1, 1, 1, −1 and a square wave.

The SFD signal may be a signal obtained by performing an XOR operation on a 4 bit signal of −1, 1, 1, −1 and a square wave.

### BRIEF DESCRIPTION OF THE DRAWINGS

FIG. 1 is a block diagram illustrating a tag transmitting apparatus of a passive RFID system according to an exemplary embodiment of the present invention.

FIG. 2 is a diagram illustrating the structure of a data packet according to an exemplary embodiment of the present invention.

FIG. 3 is a diagram illustrating a preamble signal according to an exemplary embodiment of the present invention.

FIG. 4 is a diagram illustrating an auto-correlation characteristic when a square wave is used as a carrier in a preamble according to an exemplary embodiment of the present invention.

FIG. 5 is a diagram illustrating a cross-correlation characteristic when a square wave having a different transmission speed from a preamble signal according to an exemplary embodiment of the present invention is used as a subcarrier.

FIG. 6 is a diagram illustrating a pilot tone signal according to an exemplary embodiment of the present invention.

FIG. 7 is a block diagram illustrating a method of estimating a frequency of a reader receiving apparatus according to an exemplary embodiment of the present invention.

FIG. 8 is a diagram illustrating the output waveform of the cross-correlation value of FIG. 7.

FIG. 9 is a diagram illustrating a reader receiving apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

A tag transmitting apparatus and method and a reader receiving apparatus according to an exemplary embodiment of the present invention are described hereafter in detail with reference to the drawings.

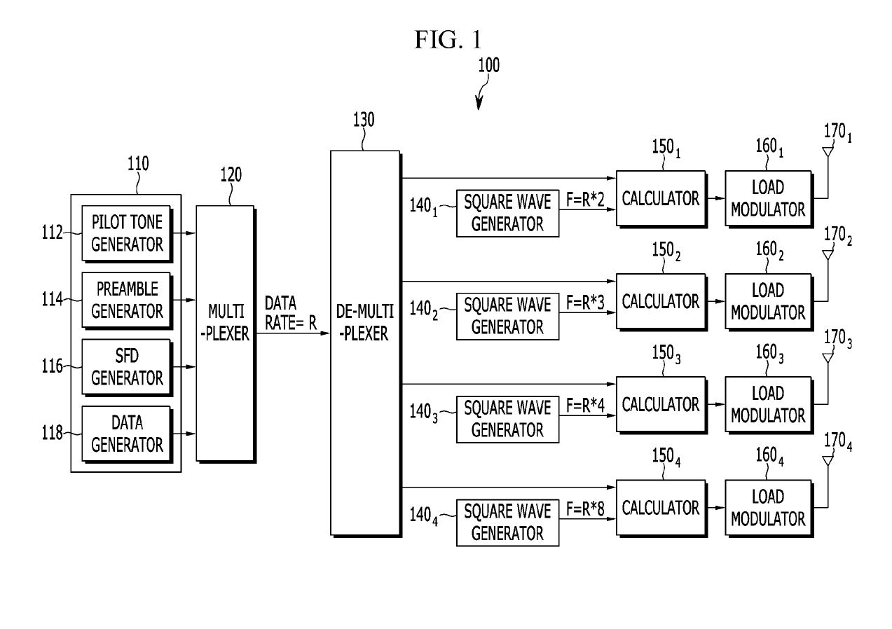

FIG. 1 is a block diagram illustrating a tag transmitting apparatus of a passive RFID system according to an exemplary embodiment of the present invention.

Referring to FIG. 1, a tag transmitting apparatus 100 of a passive RFID (radio frequency identification) system includes a signal generator 110, a multiplexer 120, a de-multiplexer 130, a plurality of square wave generators 140₁-140ₙ, a plurality of calculators 150₁-150ₙ, a plurality of load modulators 160₁-160ₙ, and a plurality of tag antennas 170₁-170ₙ. It is assumed in FIG. 1 that n is 4 for convenience of description.

The signal generator 110 includes a pilot tone generator 112, a preamble generator 114, an SFD (start frame delimiter) generator 116, and a data generator 118.

The pilot tone generator 112 generates first and second pilot tones, and transmits the first and second pilot tones to the multiplexer 120. The preamble generator 114 generates a preamble and transmits the preamble to the multiplexer 120. The SFD generator 116 generates an SFD and transmits the SFD to the multiplexer 120. The data generator 118 stores tag data, for example, an identifier of a tag and data of a product with a tag, and transmits the tag data to the multiplexer 120.

The multiplexer 120 selectively transmits the pilot tones, the preamble, the SFD, and the tag data to the de-multiplexer 130.

The de-multiplexer 130 transmits the first pilot tone, the second pilot tone, the preamble, and the SFD to the calculator 150₁. Further, the de-multiplexer 130 converts the tag data into a plurality of parallel data and transmits the parallel data to the calculators 150₁-150₄. That is, the tag data can be transmitted in a parallel format.

The square wave generators 140₁-140₄ generate square waves for predetermined frequencies, respectively, and output the square waves to the corresponding calculators 150₁-150₄.

In general, the subcarrier that is used for IFFT (inverse fast Fourier transform) of an OFDM (orthogonal frequency division multiplexing) transmitter is a sine wave in which each subcarrier has only one frequency component. It is difficult to transmit a sine wave from the tag of a passive RFID system, since square waves are generated by the square wave generators 140₁-140₄ and used as subcarriers.

The subcarrier of a sine wave is different in frequency configuration from the subcarrier used in the IFFT of the OFDM transmitter. Frequencies corresponding to all natural multiples between one and K times a fundamental frequency, which is the data rate of each channel, are used in the IFFT of the OFDM transmitter. The square wave, however, includes a harmonic wave component at the frequencies that are odd-numbered multiples of the fundamental frequency. Therefore, for the frequency of a square wave that is used as a sub-carrier, the frequencies of the harmonic waves generated by different sub-carriers are not used, but frequencies having inter-subcarrier orthogonality are used.

Table

Table 1 shows harmonic wave components generated in subcarriers that are integer multiples of the data rate when the data rate is normalized to 1.

| Subcarrier frequency | Harmonic frequency generated by |
|---|---|
| (data rate = 1) | subcarrier |
| 1 | 3, 5, 6, . . . , (2 * k + 1) |
| 2 | 6, 10, 14, . . . , 2 * (2 * k + 1) |
| 3 | 9, 15, 21, . . . , 3 * (2 * k + 1) |
| 4 | 12, 20, 28, . . . , 4 * (2k + 1) |
| . | |
| . | |
| . | |
| m | M * 3, m * 5, m * 7, . . . , m * (2 * k + 1) |

The available combinations of subcarrier frequencies based on the analysis in Table 1 may be very various.

Table 2 shows an example of available subcarrier frequencies based on the analysis in Table 1.

Table 2 shows the subcarrier frequencies to the extent of 16 times a data rate.

TABLE 2

| Frequency of excepted | Combination of frequency of available |
|---|---|
| subcarrier (data rate = 1) | subcarrier |
| 0 | 1, 2, 4, 8, 11, 13, 16 |
| 1 | 2, 3, 4, 5, 7, 8, 11, 13, 16 |
| 1, 2 | 3, 4, 5, 6, 7, 8, 10, 11, 13, 14, 16 |
| 1, 2, 3 | 4, 5, 6, 7, 8, 9, 10, 11, 13, 14, 15, 16 |

Referring to Table 2, when there is only the DC component in the frequencies of the excepted subcarriers (frequency of excepted subcarriers=0), there are seven available subcarriers (1, 2, 4, 8, 11, 13, and 16) in the sixteen subcarriers, and the use ratio is about 44%. When the frequencies of the subcarriers of (data rate*1) are excepted, the use ratio is about 56%, when the frequencies of the subcarriers of (data rate*1) and (data rate*2) are excepted, the use ratio is about 69%, and when the frequencies of the subcarriers of (data rate*1), (data rate*2), and (data rate*3) are excepted, the use rate of the available subcarriers is about 75%.

In the available subcarriers, square waves having different frequencies can be generated by the square wave generators 140₁-140ₙ. For example, when the frequency of the subcarrier of (data rate*1) is excepted, the square wave generators 140₁-140ₙ can generate square waves having different frequencies in “2, 3, 4, 5, 7, 8, 13, 16”, respectively. Accordingly, the square waves generated by the square wave generators 140₁-140ₙ maintain orthogonality with each other. For example, the square wave generators 140₁-140₄ can generate square waves having frequencies (F=R*2, F=R*3, F=R*4, F=R*8) of two times, three times, four times, and eight times the data rate (R), respectively.

The calculators 150₁-150₄ perform an XOR (exclusive OR) operation on the data inputted from the de-multiplexer 130 with the subcarriers of the corresponding square waves, and output them to the modulators 160₁-160₄.

The load modulators 160₁-160₄ respectively perform load modulation on the subcarriers and output them through the tag antennas 170₁-170₄.

The tag antennas 170₁-170₄ output signals for the subcarriers that have undergone load modulation by the load modulators 160₁-160₄.

As described above, by using the square waves, which are orthogonal to each other and have frequencies, except the inter-subcarrier harmonic frequency, as subcarriers, the tag transmitting apparatus 100 can transmit tag data in several subcarriers having orthogonality without interference, similar to OFDM. Therefore, it is possible to improve bandwidth efficiency in comparison to the single subcarrier-based transmission method of the existing passive RFID systems.

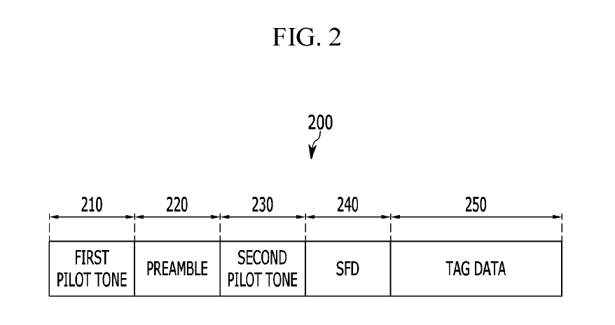

FIG. 2 is a diagram illustrating the structure of a data packet according to an exemplary embodiment of the present invention.

Referring to FIG. 2, a data packet 200 includes a pilot tone field 210, a preamble field 220, a pilot tone field 230, an SFD field 240, and a data payload 250.

The pilot tone field 210 includes a first pilot tone. The first pilot tone is used for compensating for DC offset in a reader receiving apparatus, and may not be used in some cases.

The preamble field 220 includes a preamble. The preamble is used for detecting the existence of a tag transmission signal in a reader receiving apparatus. The preamble may be used for identifying a protocol message. That is, the preamble makes it possible to check whether it is a response message from a tag to a reader.

The pilot tone field 230 includes a second pilot tone. The second pilot tone is used for estimating the transmission speed of a tag transmission signal in a reader receiving apparatus and for phase recovery and auto gain control of a subcarrier.

The SFD field 240 includes an SFD. The SFD is used for detecting the start point of a payload in a reader receiving apparatus. The SFD has a bit signal that is the same as that of the preamble.

The data payload 250 includes tag data.

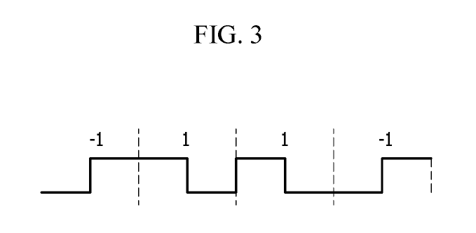

FIG. 3 is a diagram illustrating a preamble signal according to an exemplary embodiment of the present invention.

Referring to FIG. 3, auto-correlation and cross-correlation characteristics of the preamble are important for accurate detection of a tag transmission signal. The preamble generator 114 uses a 4 bit signal of “−1, 1, 1, −1” for a preamble in consideration of the auto-correlation and cross-correlation characteristics of the preamble. The 4 bit signal of “−1, 1, 1, −1” undergoes XOR calculation with a square wave by the calculator 150₁, and as a result, the preamble shown in FIG. 3 or an SFD signal is received by a reader receiving apparatus. The square wave may be replaced with a waveform obtained by multiplying a square wave by a series such as a PN code.

As a result, a preamble signal in which the bit “−1” is expressed by Low-High and the bit “1” is expressed by High-Low is received by the reader receiving apparatus.

The SFD generator 116 also uses a 4 bit signal of “−1, 1, 1, −1” for an SFD, the same as the preamble. Therefore, the SFD signal received by the reader receiving apparatus can be the same as that shown in FIG. 3.

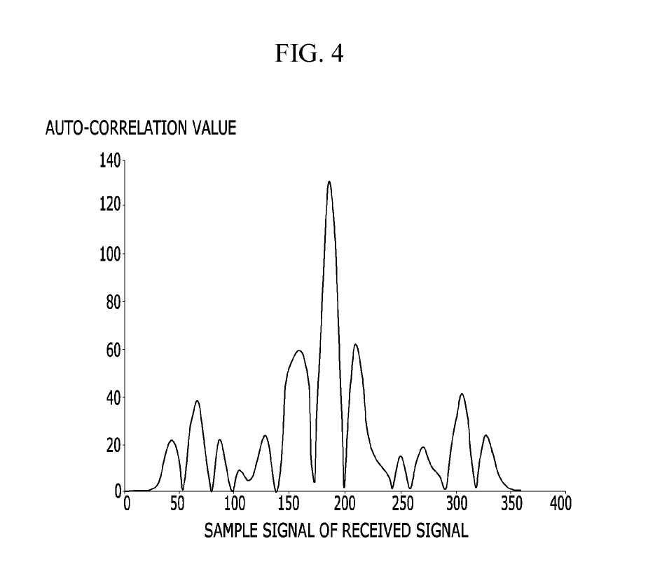

FIG. 4 is a diagram illustrating an auto-correlation characteristic when a square wave is used as a carrier in a preamble according to an exemplary embodiment of the present invention.

Referring to FIG. 4, the maximum correlation value of the auto-correlation characteristic is about 135 and the second correlation value is about 60 under the condition that transmission speed offset is 20% and an SNR is 10 dB. Since the difference between the maximum correlation value and the second correlation value is large in a preamble, as described above, it is possible to detect whether a tag transmission signal is detected, at an accurate point of time, when the reader receiving apparatus receives a tag transmission signal.

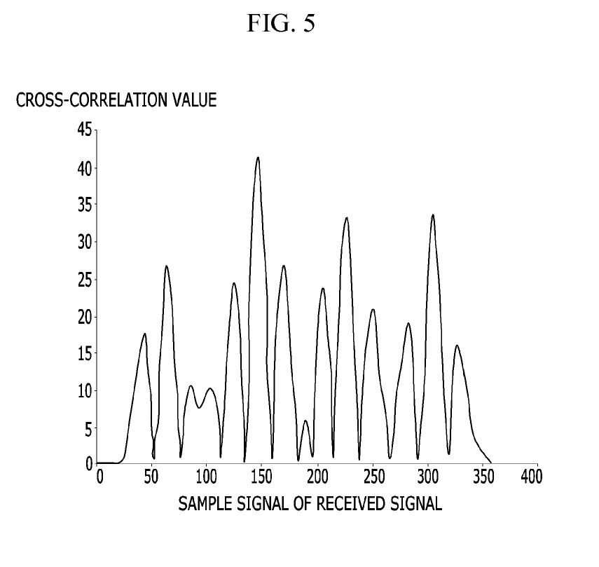

FIG. 5 is a diagram illustrating a cross-correlation characteristic when a square wave having different a transmission speed from a preamble signal according to an exemplary embodiment of the present invention is used as a subcarrier.

Referring to FIG. 5, the maximum correlation value of the cross-correlation characteristic is about 40 under the condition that transmission speed offset is 20% and SNR is 10 dB, and from which it is possible to know that the maximum correlation value of the cross-correlation characteristic when a square wave having a different transmission speed from a preamble is used differs greatly from 135 as the maximum correlation value of the auto-correlation characteristic shown in FIG. 4.

That is, it is possible to detect a tag transmission signal at an accurate point of time, even if the transmission speed of the preamble signal changes, by detecting the tag transmission signal using the auto-correlation of the preamble signal.

There is a great difference between the tolerance for change in transmission speed of the tag transmission speed in a passive RFID system and the tolerances in common communication systems. The degree of ppm is allowable in common communication systems, such that it is not required to estimate the transmission speed of a reception signal. The passive RFID system, however, allows up to 10% or more of transmission speed offset. Accordingly, a device for timing synchronization of a sampling position is required. However, since speed changes of the passive RFID system are very large, transmission speed estimation is required first.

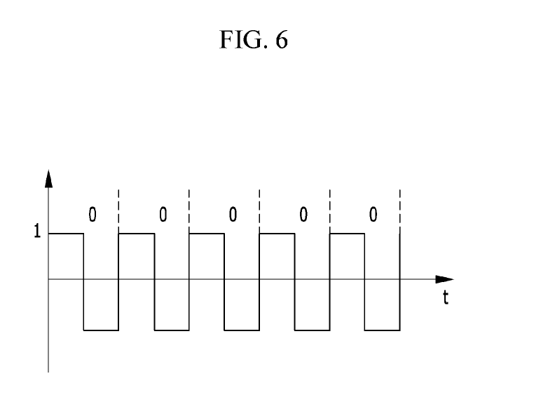

FIG. 6 is a diagram illustrating a pilot tone signal according to an exemplary embodiment of the present invention.

Referring to FIG. 6, the pilot tone generator 112 generates several bits composed of zeros for the first and second pilot tones. For example, the pilot tone generator 112 can use 10-bit or more signals composed of only zeros for the first and second pilot tones.

The bit signals undergo XOR calculation with a square wave by the calculator 150₁. Then, a pilot tone signal as shown in FIG. 6 is received by a reader receiving apparatus.

That is, the pilot tone signal received by the reader receiving apparatus is a cyclical square wave. The pilot tone signal has a frequency that is proportional to the transmission speed of a tag transmission signal. Accordingly, it is possible in the reader receiving apparatus to estimate the transmission speed of a tag transmission signal, using the method of measuring the frequency of a pilot tone signal. In general, as the method of measuring a frequency, there may be a method using a PLL (phase locked loop), a method using an AFC (automatic frequency controller), and a method using a counter. However, those methods have problems. The method using a PLL needs a large number cycles of signals for estimation. As for the AFC method, a CW (continuous wave) signal is required for accurate estimation, but the CW signal cannot be implemented as a real number signal such as those described above, because it is a complex signal. The method using a counter has two restrictions. The first is that it is difficult to accurately count a frequency because of noise, and the second is that it is difficult to accurately estimate a frequency because of a limit in operation speed when a frequency counter digitally operates.

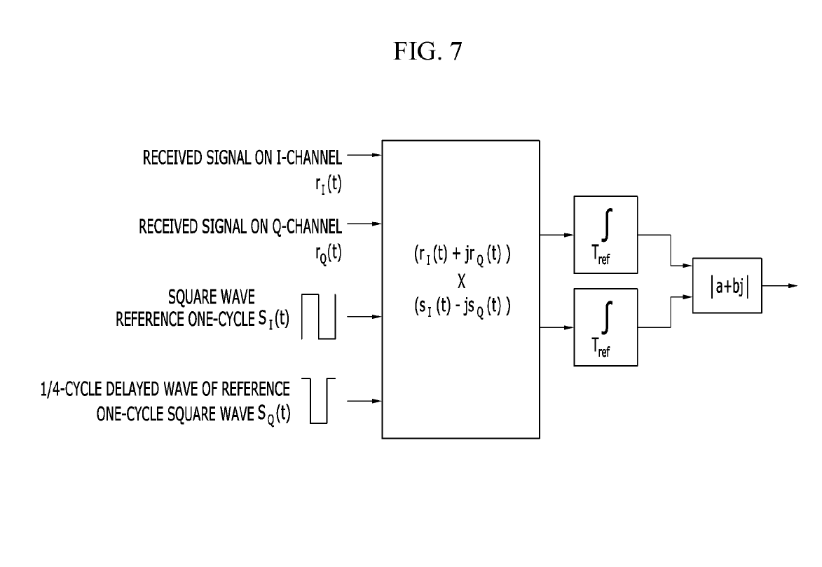

FIG. 7 is a block diagram illustrating a method of estimating a frequency of a reader receiving apparatus according to an exemplary embodiment of the present invention.

Referring to FIG. 7, a reader receiving apparatus has a unit of one cycle (T_{ref}) of a reference square wave as a reference signal, and calculates the cross-correlation value of the reference signal and a second pilot tone signal, which is a received signal.

Assuming that the received signal r(t) is r_{I}(t)+jr_{Q}(t) and the reference signal s(t) is s_{I}(t)−js_{Q}(t), js_{Q}(t) may be a signal delayed by ¼ of the cycle of the reference square wave. The reader receiving apparatus can calculate the cross-correlation value of r(t) and s(t) by multiplying r_{I}(t)+jr_{Q}(t) by s_{I}(t)−js_{Q}(t), integrating the I signal and the Q signal for one cycle (T_{ref}), and then summing them.

It is important to calculate the correlation value for one cycle (T_{ref}) in estimation of a frequency. When the magnitudes of the reference signal and the received signal are At and Ar, respectively, the cross-correlation value can be expressed as in Equation 1, when there is a difference of t between the reference signal and the received signal.

Aₜ·Aᵣ·(T_{ref}−4t) (Equation 1)

As shown in Equation 1, it can be seen that the cross-correlation value has a linear relationship with the time difference between the reference signal and the received signal. Therefore, it is possible to estimate the transmission signal of a tag transmission signal from the cross-correlation value.

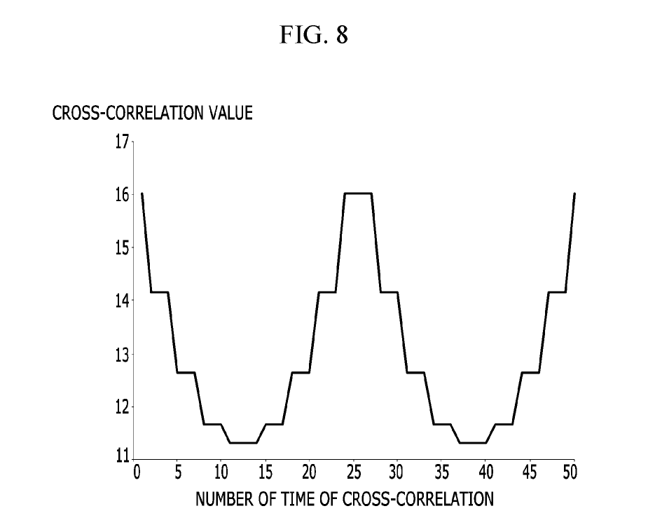

FIG. 8 is a diagram illustrating the output waveform of the cross-correlation value of FIG. 7. One cycle (T_{ref}) of the reference signal is defined as 32 samples, and the difference in transmission speed between the received signal and the reference signal is assumed to be 1%, in FIG. 8.

Referring to FIG. 8, it can be seen that the cross-correlation waveform has the shape of a quadratic function. The cross-correlation signal in Equation 1 was analyzed on the basis of the baseband signal and the reference signal of a tag transmission signal, with r_{Q}(t) and s_{Q}(t) removed from FIG. 7, and there is only the action of r_{I}(t) and s_{I}(t). However, there are also r_{Q}(t) and s_{Q}(t) in the actual environment. Accordingly, the cross-correlation waveform has the shape shown in FIG. 8 due to the interaction of four signals of r_{I}(t), s_{I}(t), r_{I}(t), and s_{I}(t).

When the difference in transmission speed between the received signal and the reference signal is 1%, a time delay of one cycle is generated after time corresponding to one hundred cycles. However, the reference signal of the Q-channel is delayed by ¼ more than the reference signal of the I-channel, such that a signal having 25 cycles is outputted, as shown in FIG. 8. It is possible to estimate the transmission speed of the tag transmission signal by measuring the cycle of the outputted signal. When the cycle of the outputted signal is 25, as shown in FIG. 8, it can be determined that there is a transmission speed offset of 1% between the received signal and the reference signal.

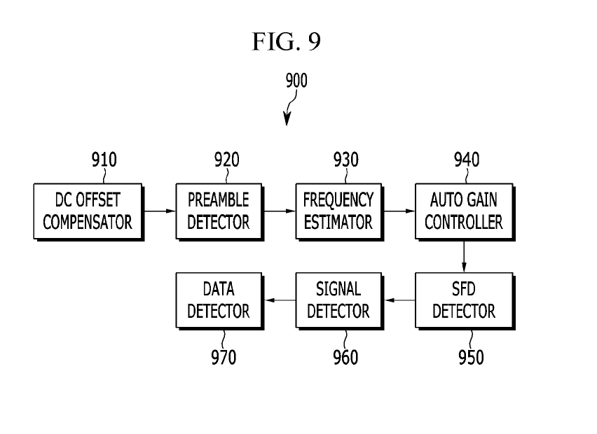

FIG. 9 is a diagram illustrating a reader receiving apparatus according to an exemplary embodiment of the present invention.

Referring to FIG. 9, a reader receiving apparatus 900 include a DC offset compensator 910, a preamble detector 920, a frequency estimator 930, an auto gain controller 940, an SFD detector 950, a fast Fourier transformer (hereafter referred to as “FFT”) 960, and a data detector 970.

A subcarrier signal received through a reader antenna is converted into I- (in-phase) and Q- (quadrature-phase) signals of the baseband through a mixer (not shown). The mixer uses a reference frequency generated by a local oscillator. A large DC offset is generated, especially in a DCR (direct conversion receiver) structure. In the DCR, the center frequency of a received signal and the frequency of a local oscillator signal inputted to the mixer are the same. Self-mixing is generated in mixing of the mixer due to the circuit characteristic of the mixer, such that DC offset is generated.

The DC offset compensator 910 compensates for the DC offset of the received signal by finding the DC offset from the I-signal and the Q-signal of the first received pilot tone signal.

The preamble detector 920 detects whether there is a tag transmission signal, using auto-correlation of the received signal, that is, the preamble signal.

The frequency estimator 930 estimates frequency offset, that is, transmission speed offset, of the received signal, using the cross-correlation of the second received pilot tone signal and the reference signal, and estimates the transmission speed offset of the received signal. The frequency estimator 930 can estimate the transmission speed offset of a received signal on the basis of the method described with reference to FIG. 7. The frequency estimator 920 can estimate accurate transmission speed from the cross-correlation with the reference signal, using the square wave shown in FIG. 6 as a pilot tone signal, as described above.

The auto gain controller 940 controls the magnitude of the received signal with the DC offset and the compensated transmission speed offset, using the cross-correlation value between the second pilot tone signal and the reference signal.

The SFD detector 950 detects payload, that is, the start position of the actual tag data, using the cross-correlation between the received signal, that is, the SFD signal and the reference SFD signal. The reference SFD signal may be a signal the same as the SFD signal that is used in the tag transmitting apparatus 100. As described above, by using the square wave shown in FIG. 3 in the tag transmitting apparatus 100 as the SFD signal, the SFD detector 950 can accurately determine the start point of time of the actual tag data.

The FFT 960 converts and outputs I- and Q-signals that have undergone auto gain control into a signal in the frequency region, by performing FFT at the start point of time of the payload, using the signal as an input. That is, the I- and Q-signals that have undergone auto gain control are divided into signals in the subcarrier bands, respectively, by FFT.

The data detector 970 detects tag data from the signals divided in the subcarrier bands, respectively, by the FFT 960.

As described above, a tag transmitting apparatus of a passive RFID system according to an exemplary embodiment of the present invention can accurately determine whether there is a tag transmission signal and the start point of the actual tag data by means of the reader receiving apparatus 900 receiving the tag transmission signal, by transmitting a preamble, a pilot tone, and an SFD, using the subcarrier of a square wave, and can improve the transmission speed estimation performance, so that it can improve the communication performance in comparison to the existing RFID systems.

Exemplary embodiments of the present invention are not implemented only by the apparatus and/or method described above, and may be implemented by programs that implement the function of the configurations in the exemplary embodiments of the present invention or a recording medium having the programs, and the present invention can be easily implemented by those skilled in the art from the exemplary embodiments described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting tag data in a passive RFID (radio frequency identification) system, the method comprising:
generating a pilot tone, a preamble, and an SFD (start frame delimiter);
generating a plurality of square waves; and
transmitting the pilot tone, the preamble, and the SFD using one of the square waves.

2. The method of claim 1, further comprising:
converting tag data inputted in series into a plurality of parallel data; and
transmitting the parallel data using the square waves.

3. The method of claim 2, wherein the square waves are orthogonal to each other.

4. The method of claim 1, wherein the preamble includes a 4 bit signal.

5. The method of claim 4, wherein the 4 bit signal is −1, 1, 1, and −1.

6. The method of claim 1, wherein the SFD includes a 4 bit signal.

7. The method of claim 6, wherein the 4 bit signal is −1, 1, 1, and −1.

8. The method of claim 1, wherein the pilot tone includes a bit signal composed of zeros, and is used for estimating transmission speed of a transmitted signal from the tag.

9. An apparatus for transmitting a tag which transmits tag data in a passive RFID (radio frequency identification) system, the apparatus comprising:
signal generators that each generate a pilot tone, a preamble, an SFD (start frame delimiter), and tag data;
a plurality of square wave generators that generate a plurality of square waves to use as subcarriers;
a plurality of calculators that calculate and output input data and a plurality of square waves, respectively;
a plurality of load modulators that perform load modulation on the signals of the square waves and then transmit the signals, respectively; and
a de-multiplexer that outputs the pilot tone, the preamble, and the SFD to one of the square wave generators, converts the tag data into a plurality of parallel data, and then outputs the parallel data to the square wave generators.

10. The apparatus of claim 9, wherein the square waves are orthogonal to each other.

11. The apparatus of claim 9, wherein the preamble and the SFD include a 4 bit signal.

12. The apparatus of claim 10, wherein the 4 bit signal is −1, 1, 1, and −1.

13. The apparatus of claim 9, wherein the pilot tone includes a bit signal composed of zeros, and is used for estimating transmission speed of the tag.

14. The apparatus of claim 10, wherein a selected one of the square wave generators generates a square wave having a lowest frequency in the square waves.

15. A reader receiving apparatus that receives a tag signal from a tag of a passive RFID (radio frequency identification) system, the apparatus comprising:
a frequency estimator that estimates transmission speed offset of a received signal, using cross-correlation between a received pilot tone signal and a reference pilot tone signal, and compensates for the transmission speed offset;
a preamble detector that detects whether there is a tag signal, using auto-correlation of a received preamble signal; and
an SFD (start frame delimiter) detector that detects a start point of time of a payload from the tag signal, using cross-correlation between a received SFD signal and a reference SFD signal.

16. The apparatus of claim 15, wherein the pilot tone signal is a signal obtained by performing an XOR (exclusive OR) operation on continuous 0 bit signals and a square wave.

17. The apparatus of claim 16, wherein the frequency estimator multiplies an I-signal of the pilot tone signal by one cycle signal of the square wave, multiplies a Q-signal of the pilot tone signal by a cycle signal delayed by ¼ of the square wave, estimates frequency offset from the sum of the signals, and estimates transmission speed offset from the frequency offset.

18. The apparatus of claim 15, wherein: the preamble signal is obtained by performing an XOR operation on a 4 bit signal of −1, 1, 1, −1 and a square wave.

19. The apparatus of claim 15, wherein the SFD signal is a signal obtained by performing an XOR operation on a 4 bit signal of −1, 1, 1, −1 and a square wave.
